(19) United States
(12) Patent Application Publication
(10) Pub. No.: US 2008/0215468 A1
(43) Pub. Date: Sep. 4, 2008

(54) Software Licensing Method And System

(75) Inventors: Assaf Yossef Monsa-Chermon, Westbury, NY (US); Arad Uri, New York, NY (US)

Correspondence Address: Martin D Moynihan;PRTSI, Inc., P O Box 16446, Arlington, VA, 22215, US

(73) Assignee: DOUBLE TRUMP INTERNATIONAL INC., New York, NY (US)

(21) Appl. No.: 11/794,737

(22) PCT Filed: Jan. 6, 2006
(86) PCT No.: PCT/US2006/000287

§ 371 Date: Jul. 5, 2007

Related U.S. Application Data
(60) Provisional application No. 60/641,850, filed on Jan. 6, 2005.
(60) Provisional application No. 60/650,224, filed on Feb. 4, 2005.

(51) Int. Cl. G06Q 10/00; G06Q 30/00

(52) U.S. Cl. 705/34; 705/39; 705/1; 705/400

(57) ABSTRACT

A software and/or content licensing method, which, in some embodiments, an intermediate entity brokers a plurality of software vendors to a single user, who can pay for only actual use of the software, through the single entity. In some embodiments, there is a cap. In some embodiments, offline use of the pay-per-use software is supported.

The present invention claims the benefit under 119(e) of U.S. Provisional Application No. 60/641,850 filed Jan. 6, 2005 and U.S. Provisional Application No. 60/650,224 filed Feb. 4, 2005 with Uri Arad as one of the inventors in both applications, the disclosures of which are incorporated herein by reference.

### FIELD OF THE INVENTION

The present invention relates to the field of license management, for example for software or other content.

### BACKGROUND OF THE INVENTION

In standard use, a user purchases a software title in a store, installs the software on a computer at home and may need to enter a key or activate the software against a remote location, prior to or during use of the software. Such standard use has various shortcomings, including the need to expend substantial capital in purchasing software, which may turn out to be not useful.

Various solutions have been proposed in the art, including trial periods and software rental.

U.S. Pat. No. 6,966,000, the disclosure of which is incorporated herein by reference, describes granting the use of software features by remote, pay per use, licensing.

U.S. Pat. No. 5,925,197, the disclosure of which is incorporated herein by reference, describes a system that contains a check-in/check-out module and a software monitor used to determine the permission to use certain computer software.

U.S. Pat. No. 6,049,789, the disclosure of which is incorporated herein by reference, discusses a software pay-per-use licensing system, including a licensor license management system (LMS) and a licensee LMS. Each licensee LMS includes components that operate to grant pay-per-use licenses for software applications, and each licensor LMS includes components that operate to receive, store and process state and usage license granted data for the software applications from the licensee systems, including verification of timely periodic reporting from the licensee LMS.

### SUMMARY OF THE INVENTION

A broad aspect of some embodiments of the invention relates to licensing software and/or content in a manner that requires minimal attention from the user. Optionally, the attention minimized comprises accounting attention. Alternatively or additionally, the attention minimized comprises risk analysis attention. Optionally, the attention minimized comprises negotiation attention. Alternatively or additionally, the attention minimized comprises software installation and/or license management attention.

In an exemplary embodiment of the invention, a single end user license covers the use of multiple software, optionally from different vendors. This may significantly reduce the complexity of software management.

In an exemplary embodiment of the invention, a video-rental-like model is provided, in which a user has a business relationship with a source of many software titles from multiple software manufacturers and/or vendors having multiple and different licensing schemes, and the user, who deals directly only with the source, has the complexity of different software usage options buffered by the source.

In an exemplary embodiment of the invention, the licensing is of multiple software titles, where the license agreement and billing terms are set in advance, and usage of each title is allowed upon installation.

In an exemplary embodiment of the invention, a user has a plurality of local software titles and usage of these software titles is controlled by a number of license certificates smaller than the number of titles, optionally one license certificate, optionally for multiple software vendors.

Optionally, the license provider is commercially independent of one or more of the software vendors. For instance, the license provider may provide licenses to software of competing vendors, or other wise cooperate with the competitors, and is not committed to the vendors, other than by commitment to pay for their products, and similar commitments typical to relations between independent entities. In one embodiment, the licensor is not owned by any one of the vendors. In one embodiment, the licensor and the vendor do not have common owners.

Optionally, the service is branded. Optionally the brand helps potential users to identify software that may be licensed in accordance with the invention.

Non-limiting examples for number of license certificates on a user machine are 1, 2, 5, 8, 15, and intermediate or greater numbers. Non-limiting examples of number of software titles on a single user machine are 2, 3, 4, 10, 20, and intermediate or greater numbers. Non-limiting examples of number of vendors of software titles made available by a single license certificate are 1, 2, 3, 5, 10, and intermediate or greater numbers.

In an exemplary embodiment of the invention, payment by the user is only to a single source/collection agency.

In an exemplary embodiment of the invention, payment is only for actual use of software.

In an exemplary embodiment of the invention, a single licensing system provides multiple license types to a user including trial licenses, limited usage licenses, permanent licenses, site licenses and/or package licenses. Optionally, these multiple license types are provided with a single license certificate.

Some embodiments of the invention allow registered users to avoid registration and/or activation activities of software. Optionally, the user may be presented with a notice when she first activates the application and may be required to confirm that she may be charged for the use of the software. Optionally, the user may be presented with such a notice whenever she activates the application.

In some embodiments of the invention, an application resident on the user's machine, also referred herein as the client application or the local component, will send usage data to a server. This data may be used in an aggregated form to provide content developers, and other parties with data about content usage, usage patterns and more. The data may be further used to help content developers develop new content that better fits the market need. Optionally, the data may be used to characterize the user and offer the user new content that is more likely to be used and enjoyed by the user. Such uses may increase user satisfaction and revenue generation.

In some embodiments payment by the user is only for usage of a software title, and not for the general right to use it. This is termed “pay per use” or “pay as you go”.

Some embodiments of the invention allow only online use of the licensed software. Other embodiments allow offline use of the software, and optionally require only a periodic online refreshing of license balance and user's account. Optionally, payment is only according to actual use.

Some embodiments of the invention include a charge cap, which ensures that the user does not pay for usage more than a certain sum. Optionally, once the cap is reached the user is granted a free license for the software. Optionally, the free license is permanent. Alternatively, the free license is until a certain date (for instance until the end of the month). The two possibilities may be combined (for instance, after paying no more than an agreed sum per month, if the payments accumulate to a certain sum, any further usage is free). Optionally, the cap is shared between multiple titles and/or shared between titles of multiple vendors, depends on user's usage and/or depends on usage by other users.

As noted, some embodiments allow the usage of many software titles under a single license certificate. In such embodiment, a user may have the managed permission to use various software titles while paying only for the usage made in fact. In some embodiments, after the total charge for using one title of the package reached the purchase price of this title, the user can continue to use this title free of charge, and being charged only for use of other titles. In another embodiment, the cap is set on total usage of all (or certain) titles in a package.

An aspect of some embodiments of the invention relates to a method of license management in which a license balance, which allows a relatively small number of usage units is updated as needed. Optionally, payment is required only for actual usage, independent of the number of unused usage units that the user has received. In an exemplary embodiment of the invention, a user component requests a new or updated license from a license generator responsive to usage of the local license. Optionally, payment is calculated based on a tracking of usage, which tracking is optionally used to indicate the diminishing of the local license by the usage.

An aspect of some embodiments of the invention relates to the possibility to use a licensed software while being offline, and being debited for this off-line activity only in next time the user is online. Optionally, if a user is not online for some period, for example two weeks or a month, or some period of actual usage of licensed software, for instance 10, 30, or 50 hours of usage, the system requests going online before continuing to use any licensed software. Optionally, this requirement is considered moot if the balance of the license is above some watermark (e.g., threshold value). Optionally, if the requirement is not responded for some time, a sanction is taken against the user, for instance, further use of licensed software is prohibited.

There is thus provided in accordance with an exemplary embodiment of the invention, a method for determining a charge for using software, comprising:
(a) allowing execution of a software title by a user;
(b) tracking the user's usage of the software;
(c) determining a charge to the user according to said tracked usage; and
(d) limiting said charge according to a cap.

In an exemplary embodiment of the invention, in (a) usage of a plurality of software titles is allowed, in (c) a charge is determined for using each of the software titles, and in (d) charging for each software title is limited by cap associated with this title.

In an exemplary embodiment of the invention, in (a) usage of a plurality of software titles is allowed, in (c) a charge is determined for using each of the software titles, and in (d) charging for a plurality of software titles together is limited by a common cap. Optionally, said plurality of software titles are owned by a plurality of software vendors.

In an exemplary embodiment of the invention, charging is only for tracked usage of software.

In an exemplary embodiment of the invention, allowing execution comprises allowing execution on an ongoing basis without requiring registration or activation of the software by the user.

In an exemplary embodiment of the invention, at least some of said tracking is carried out when the software is used during a time at which the user is not connected to a remote communication network.

In an exemplary embodiment of the invention, when charging reaches a cap the user is granted a free license for a software title.

In an exemplary embodiment of the invention, the free license is permanent. Optionally, the cap is associated with a certain software title, and is similar to a price of same software title as offered by an entity associated with said tracking.

In an exemplary embodiment of the invention, the free license is limited in time. Optionally, the cap is associated with a certain software title, and is similar to subscription price of same title, as offered by an entity associated with said tracking.

In an exemplary embodiment of the invention, the allowing in (a) is free of charge.

In an exemplary embodiment of the invention, after a user is charged a maximum of first agreed sum per month usage of software, if the payments accumulate to a second agreed sum, any further usage is free of charge.

In an exemplary embodiment of the invention, usage of different titles accumulate towards a single cap, allowing a free use of one of the titles.

In an exemplary embodiment of the invention, usage of different titles accumulate towards a single cap, allowing free use of all said different titles.

In an exemplary embodiment of the invention, the cap depends on the user's usage of software.

In an exemplary embodiment of the invention, payments that accumulate faster have a lower cap than payments that accumulate more slowly.

In an exemplary embodiment of the invention, usage of one user accumulates in favor of a cap of another user.

In an exemplary embodiment of the invention, usage of one software title accumulates in favor of a free license on a different software title.

In an exemplary embodiment of the invention, the method comprises purchase of a perpetual license by said user using both credit accumulated by said usage and direct payment.

There is also provided in accordance with an exemplary embodiment of the invention, software usage tracking system comprising:
(a) a local component associated with a software executing on a user's machine, the local component comprising a tracking module operative to track usage of said software; and
(b) a remote component comprising:
   (i) an input adapted to receive at least an indication of said usage;
   (ii) a storage location having a cap value stored therein;
   (iii) a calculator operative to calculate a charge based on said indication and said cap.

Optionally, said local component is associated with a plurality of software titles installed on a user's machine, and the input of the remote component is adapted to receive at least an indication of usage of each of said software titles, and identity of the software title associated with each usage. Optionally, said plurality of software titles are of a plurality of vendors. Alternatively or additionally, the software includes at least 5 different titles. Alternatively or additionally, said plurality of vendors includes at least 5 different vendors.

In an exemplary embodiment of the invention, said storage location has stored therein multiple cap values and identity of software titles associated therewith.

In an exemplary embodiment of the invention, said local component is adapted to carry out monitoring when the user is not connected to a remote communication network, and to send to the remote component at least an indication of the track usage when the user is connected to a remote communication network.

There is also provided in accordance with an exemplary embodiment of the invention, a method of charging a user for using software titles, the method comprising:
(a) allowing the user to use software titles of a plurality of different vendors;
(b) tracking user's usage of said software titles; and
(c) charging the user by a single entity for the tracked usage.

In an exemplary embodiment of the invention, said plurality of vendors include at least vendors.

In an exemplary embodiment of the invention, usage of each title is allowed upon installation.

In an exemplary embodiment of the invention, the allowing of (a) is by providing the user's machine with at least one license certificate; and the number of license certificates is smaller than the number of software titles allowed for use by said certificate.

In an exemplary embodiment of the invention, said software titles are made available to said user by at least two different distribution channels.

There is also provided in accordance with an exemplary embodiment of the invention, a method for using a software title comprising:
(a) connecting to a remote communication network to receive therethrough certain usage units for using software;
(b) consuming at least part of said usage units when disconnected from said communication network; and
(c) reconnecting to the remote communication network to be debited for consumed usage units.

There is also provided in accordance with an exemplary embodiment of the invention, method of using a software comprising:
(a) locating software marked as being available for execution upon installation;
(b) installing the software;
(c) using the software; and
(d) connecting to a remote communication network for being debited for usage made and being further allowed to use software similarly marked.

There is also provided in accordance with an exemplary embodiment of the invention, a method of allowing a user to use software titles from multiple vendors; the method comprising:
(a) providing the user with a non-permanent license certificate for using software titles from multiple vendors; and
(b) using said titles by said user based on said license certificate.

There is also provided in accordance with an exemplary embodiment of the invention, a licensing method, wherein (a) a remote component sends a license certificate to a local component, the license certificate permitting to run software, (b) the local component sends to the remote component information on software usage of the software by the user; (c) the remote component reacts to the information in one or more of the following ways:
(i) sending another license certificate to the local component;
(ii) billing the user for usage made;
(iii) disallowing further use of software by the user.

In an exemplary embodiment of the invention, the other license in (i) allows free use of software. Optionally, said free use is permanent. Alternatively, said free use is time limited.

In an exemplary embodiment of the invention, said free use is limited to a certain amount of usage units.

In an exemplary embodiment of the invention, more than one license certificate is sent to the client.

In an exemplary embodiment of the invention, at least one of the license certificates sent to the client provides permanent free use of one or more software titles.

In an exemplary embodiment of the invention, at least one of the license certificates sent allows the use of multiple software titles in a per-pay-use method.

There is also provided in accordance with an exemplary embodiment of the invention, a software usage tracking system comprising a local component associated with a software executing on a user's machine and a remote component, wherein:
(a) the local component comprising
   (i) a tracking module operative to track usage of said software;
   (ii) a report enforcing module, operative to require the user to allow reporting of said usage to the remote component; and
(b) the remote component comprising an input adapted to receive at least an indication of said usage.

In an exemplary embodiment of the invention, wherein the report enforcing module requires the user to connect to a remote communication network.

In an exemplary embodiment of the invention, the report enforcing module operates a predetermined period after last time the user was connected to the remote communication network. Optionally, said predetermined period is a month.

In an exemplary embodiment of the invention, the report enforcing module operates when not yet reported tracked usage of the software reaches a certain limit.

In an exemplary embodiment of the invention, said reporting is by a tamper-detecting connection to said remote component.

There is also provided in accordance with an exemplary embodiment of the invention, a method of allowing a user to use software titles, the method comprising:
(a) registering a user with a single registering entity; and
(b) said entity allowing the user to use software titles of a plurality of different vendors responsive to said registration.

Optionally, said registering comprises generating a license certificate for a user associated with a hardware fingerprint of a user machine.

In an exemplary embodiment of the invention, said registering comprises generating a license certificate for said user and associated with a hardware fingerprint of a user machine.

In an exemplary embodiment of the invention, said registering comprises generating a license certificate for said user and associated with an identification of said user.

In an exemplary embodiment of the invention, said allowing comprises allowing use of said titles from multiple user machines. Optionally, said machines are from a limited set of machines. Alternatively, said machines can be arbitrary.

In an exemplary embodiment of the invention, said allowing comprises providing multiple charging plans to said user.

There is also provided in accordance with an exemplary embodiment of the invention, a method of charging a user for use of a software, comprising:
(a) transmitting to a user computer a limited usage unit certificate;
(b) allowing usage on said computer base don said certificate; and
(c) charging said user for actual use independent of a number of usage units in said certificate.

Optionally, said transmitting of said certificate is hidden from said user.

There is also provided in accordance with an exemplary embodiment of the invention, a software usage tracking system comprising a local component associated with a software title executing on a user's machine and a remote component, wherein:
(a) the local component comprises (i) a tracking module operative to track usage of said software; and
(b) the remote component comprises:
   (i) an input adapted to receive at least an indication of said usage;
   (ii) a license generator adapted to generate both perpetual and limited usage license certificates for said local component.

There is also provided in accordance with an exemplary embodiment of the invention, a software usage tracking system comprising a local component associated with a software title executing on a user's machine and a remote component, wherein:
(a) the local component comprises:
   (i) a tracking module operative to track usage of said software;
   (ii) a certificate request module which generates requests to said remote component; and
   (iii) a certificate installation module which installs a certificate on said user machine without requiring activity by said user; and
(b) the remote component comprises:
   (i) an input adapted to receive at least an indication of said usage;
   (ii) a license generator adapted to one or more license certificates for said local component based on said usage; and
   (iii) a license certificate transmitter adapted to send said generated certificate to said local component over a public network.

### BRIEF DESCRIPTION OF THE FIGURES

Some exemplary embodiments of the invention will be further described with reference to the accompanied drawings, in which same number designations are maintained throughout the figures for each element and in which:

FIG. 1 is a flow chart of a starting process of the licensed software according to an exemplary embodiment of the invention;

FIG. 2 is a flow chart of using the licensed software, activated by the process of FIG. 1;

FIGS. 3A and 3B together are a flow chart of status check and registration, activated by the process of FIG. 1;

FIGS. 4A and 4B together are a flow chart of checking and updating license balance and account balance, activated by the process of FIG. 1;

FIG. 5 is a block diagram of a licensing system according to an exemplary embodiment of the invention; and

FIG. 6 is a block diagram of a remote component in a licensing system according to an exemplary embodiment of the invention.

### DETAILED DESCRIPTION OF EXEMPLARY EMBODIMENTS

### Overview

In an exemplary embodiment of the invention, a licensing system is provided, and includes a local component and a remote component. The local component is on the user's computer (e.g., as integral part of licensed software or separately provided or installed), and used for one or more of executing the licensed software, logging its usage, managing a local license and/or a balance thereof, and/or allowing or disallowing software usage according to the local license balance.

The remote unit is optionally used for charging the user's account in accordance with usage reports sent to it from the local component. The remote component is optionally responsible for updating user's account in accordance with charges made and terms of the agreement between the license provider and the user. Optionally, the remote component sends license certificate(s) to the local component, for instance, to restore local license balance. Optionally, a license certificate is sent automatically, i.e. without an express request from the user. The terms of use are optionally decided upon registration. A registration process is optionally carried out on the server component, via a user interface module, which in some embodiments is embedded in the local component, in some is part of the remote component.

### Some Useful Terms

In the present description and claims, a license, described to be given to a user, to be resident on a user's machine, or to be sent from the server, is a license certificate. In an exemplary embodiment of the invention a license certificate is a code installed on the user's local machine to indicate that the machine and/or its user is permitted to use certain software titles. Optionally, a license is for every software title provided in accordance with an embodiment of the invention; alternatively, it is limited to only some of these software titles. In an embodiment of the invention, a single license certificate facilitates the use of software titles that belong to different vendors. Optionally, a license may give different usage rights of software, for instance, a license may give user rights of a super-user in none, some, or all of the software titles.

Licensing is a term used herein to describe allowing software usage by provision of a license certificate. It should be noted that a separate license document may exist, and may be provided, for example, as a text file, as part of the software or published on a web site. It should also be noted that in some cases a separate license is provided between the software owner and the distribution entity, for example a license which allows renting out of software, a license limited to a certain amount of use per time period or a license that allow multiple concurrent users.

A microlicense is a license, permitting a small number of software usage units, such as 1, 3, 5, 10, 50, 100 or 1000 usage units or intermediate or greater numbers. Optionally, each usage unit or microlicense are provided as a separate file or record in a file. Optionally, the number of usage units provided in each microlicense and/or provided each time a new license certificate is sent to a user, is selected to be small relative to a recommended list price of the software. For example, a usage unit, a microlicense and/or a license certificate may relate to less than 0.01%, less than 0.1%, less than 1%, less than 5% or intermediate, smaller or greater percentages of the list price. Exemplary values are 1 cent, 10 cents and 1 US dollar.

Usage may be measured in various units, such as time of using a software title, characters typed on a word processor, number of moves a player took, number of times the software was accessed, or other small units. Different embodiments and/or different software and/or different licensing agreements may use different usage units. Usage can also be a composite of various measures, such as execution time, CPU cycles, data transfer bandwidth and number of disk accesses may be combined using a formula to generate a composite usage measure. Usage may be discrete, in units or continuous. Optionally, charging is in units. Licenses for using a single or small number of usage units is referred hereinafter as microlicense. In the following, we shall use examples of usage time as the usage unit licensed in a microlicense, but this will be for convenience, and many other usage units may be the subject of a microlicense. In an exemplary embodiment of the invention, the units are selected to be small enough so that payment therefore will be considered by a user to be substantially continuous, for example, usage units smaller than $10, smaller than $1, smaller than 50 cents, smaller than 10 cents or smaller or intermediate values. This is in contrast to some rental schemes where the usage units are large enough that a user needs to consider carefully and/or regularly whether to expend another unit (e.g., in car rental).

It should be noted that different software titles may use up “usage units” at different rates, for example, a tax calculation software may operate at twice a rate of an e-mail software. Alternatively or additionally, the measurement that determines usage may be different for different software. Optionally, the usage of the software is translated into usage units, for example, the usage units of the license being plain “units”, and the usage of one software being translated at a conversion factor of 100 keystrokes=1 usage unit, the usage of another software being translated at a conversion factor of 10 keystrokes=1 usage unit and the usage of a third software being translated as 20 save-to-disk=1 usage unit. In some embodiments, the price for a usage unit used on one software is different than the price paid for using the same usage unit on another software, for example, a user having a license that contains 1000 one-minute microlicenses, and used 10 of them on one software and 10 on another, may be charged with $1 for the usage of the first software and $40 for the usage of the other. In an embodiment of the invention, the local component is blind as to the price associated with usage units of different software titles, and this price is considered only at the remote component.

License balance is a term relating to the unused microlicenses a user has. Optionally, license balance has one or more watermarks, and the local component reacts to the balance being below or above one of the watermarks. For instance, if a license balance is below some low watermark (meaning that the license is left with small number of microlicenses), the local component may request the remote component to send a new license, such that the local license balance will be restored. In an exemplary embodiment of the invention, the number of the microlicense sent this way by the remote component is selected to reduce risk to the vendor in case a user steals a microlicense and does not pay for it. In some cases, the number microlicenses sent each time depends on a credit rating or securities of the user.

While the term “license balance” relates to the amount of usage units that are still not used by the user, the term “account balance” relates to the money that stands in credit (or debit) of a user. License balance is monitored in the local component (although may be changed by messages from the remote component). Account balance is maintained and updated in the remote component, respective to usage reports sent from the local component. Other options include controlling the account balance locally and/on the internet.

In some places in the description the term “vendor” is used. It is noted that this term is used in the most general sense, namely, an entity that has rights to some software or content, and allows use thereof, either free of charge or for payment of any sort.

As will be described below, while the description focuses on software titles, content (e.g., music, image, movies, audio) may be licensed using similar schemes. Typically, however, a local license management is provided by software or hardware (e.g., in a consumer electronics device) separate from the content itself Software for rights management, data for such software and/or licenses are optionally downloaded together with content.

### General Description of Exemplary Microlicense Management

In an exemplary embodiment, the remote component sends a license certificate (including, for example, 50 microlicenses, each of which includes 10 usage units) to the local component. In return, the local component allows the user to run the software. Once a certain portion of these microlicenses is spent by the user (or in accordance with a pre-set reporting schedule), the local component sends a notice to the remote component. Optionally, the notice includes a complete log of the usage of the software. Alternatively or additionally, the log is summarized. Optionally, the notice does not include the log, and a log is sent to the server separately.

The remote component uses the information about the usage in order to interpret it to charges and possibly rights of usage, e.g. granting of a permanent license; and instructs the local component accordingly. For instance, the remote component may send a new license to the local component, and bill the user's account for it, without requiring any confirmation from the user, if this is in accordance with the terms of the agreement. In an exemplary embodiment, billing is only after use, so a user is billed in accordance with the notice/log, rather than being billed for the license certificates sent to him. Optionally, however, the credit line of the user is updated to reflect the number of microlicenses available thereto.

In another example, for example, when the user did not agree to automatic billing, the remote component instructs the local component to send the user a message that the account balance is nearly all consumed, and ask leave to recharge it. If leave is granted, the remote component sends a license to the client and bills the user's credit card (or other payment means) for usage not charged for yet; otherwise, the user is permitted to spend the remainder of his license balance, and no more.

### Description of an Exemplary Implementation

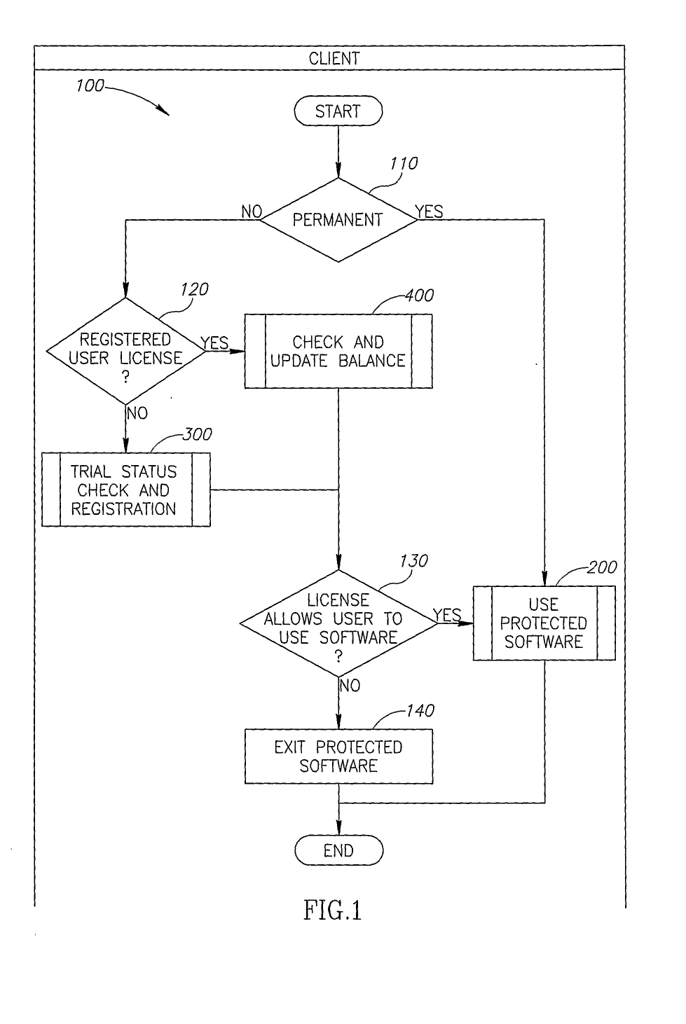

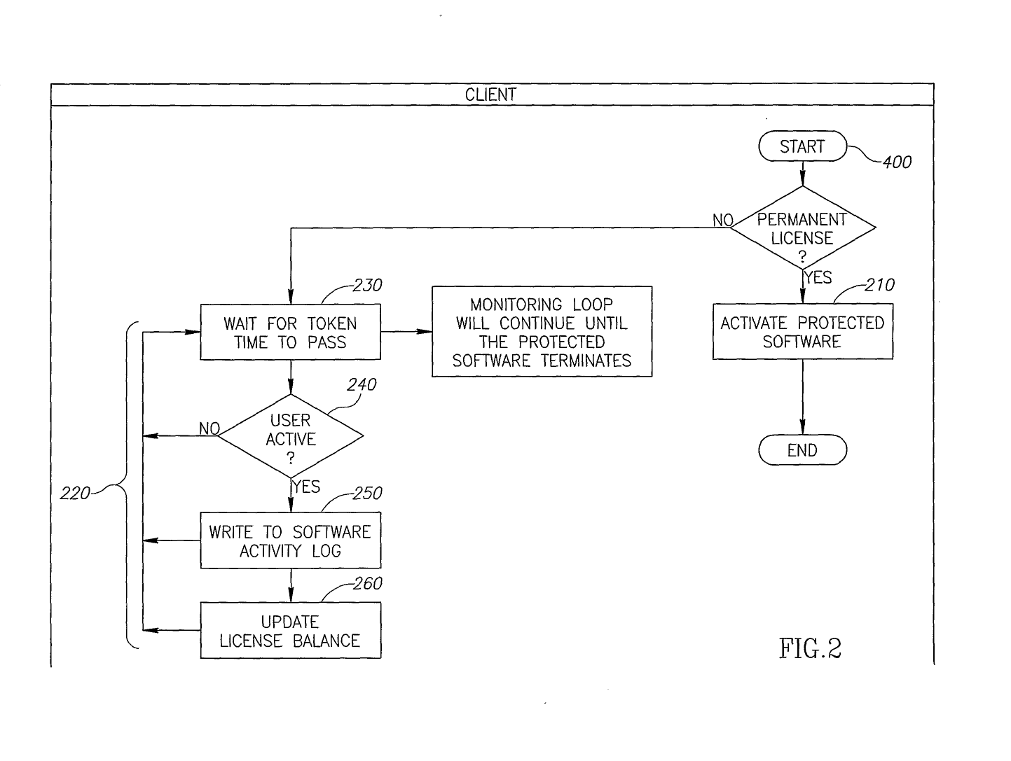

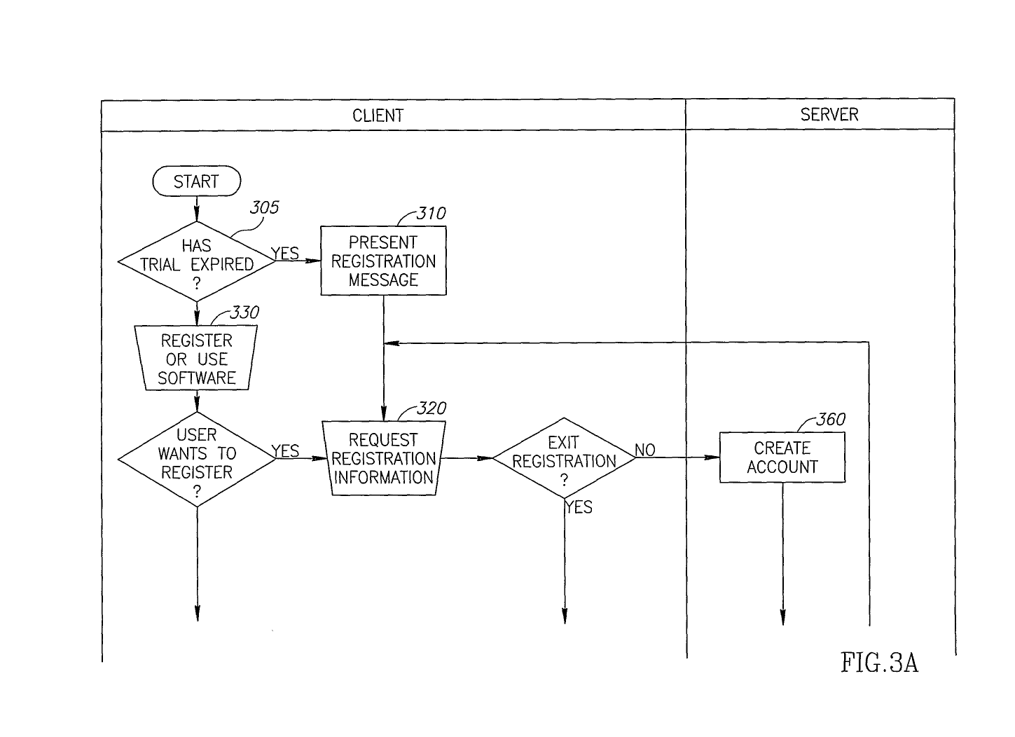

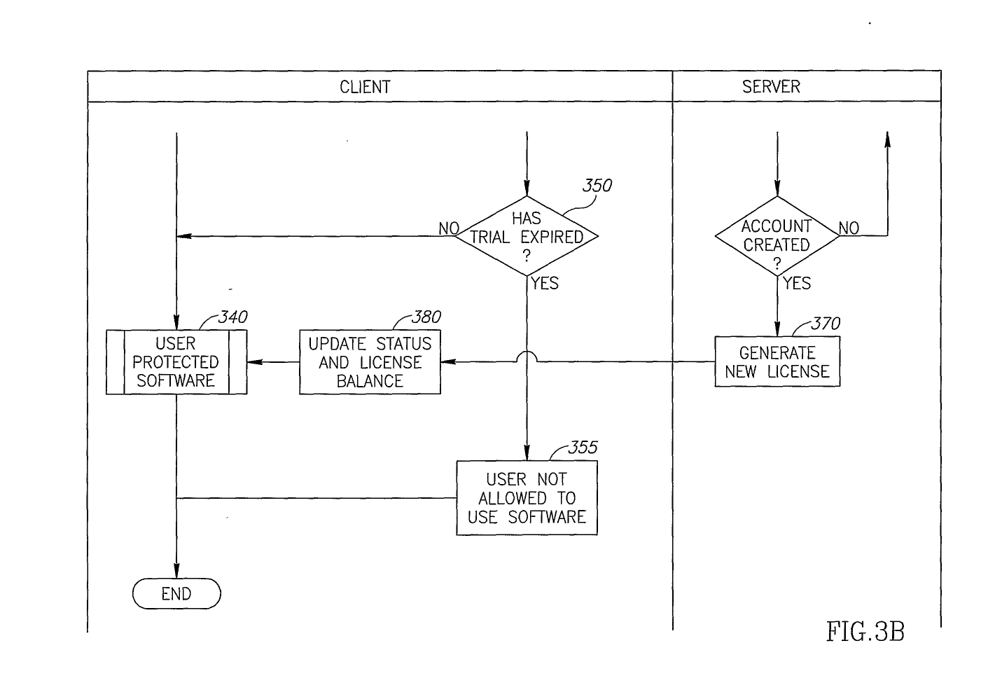

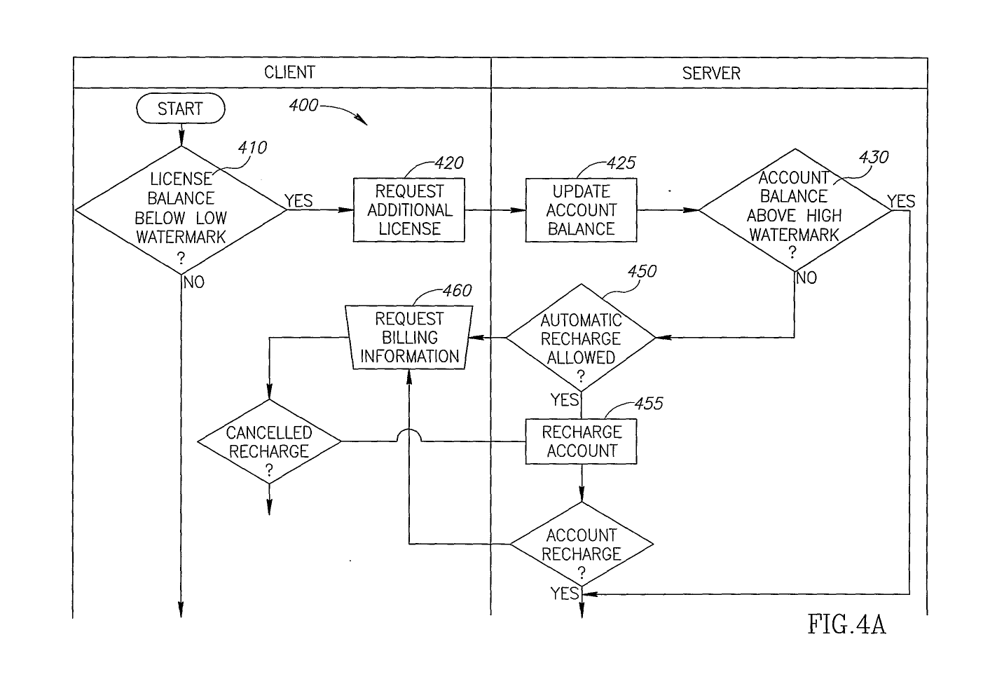

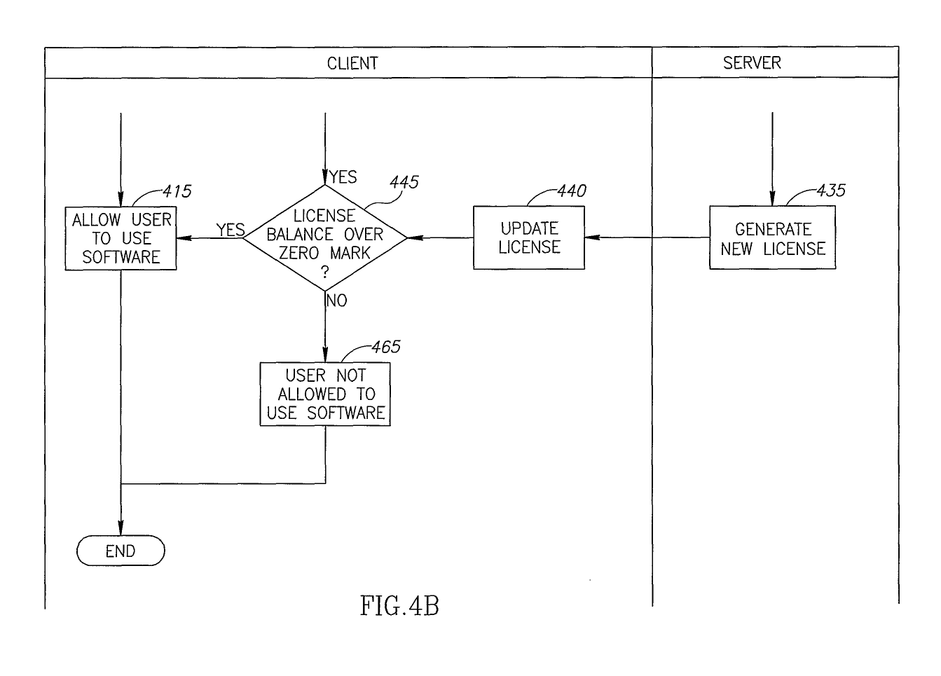

An exemplary embodiment is described in more detailed manner in FIGS. 1-4, wherein FIG. 1 is a flow chart of the starting process of the licensed software. This process activates three other processes, described in FIGS. 2-4. These three processes are: using the licensed software (FIG. 2); status check and registration (FIGS. 3A and 3B, collectively referred herein as FIG. 3); and checking and updating license balance and account balance (FIGS. 4A and 4B, collectively referred herein as FIG. 4).

FIG. 1 is a flow chart of a process (100) for starting a protected software, licensed in accordance with an exemplary embodiment of the invention. When the user starts a protected software, the local component checks (110) if the user has a permanent license for the software. If in the affirmative, the software allowed to execute (200). Additionally or alternatively, the monitoring is activated even if the user has a permanent license, such that usage of software with permanent license may still be taken into account, for instance, when charging for other software titles. For details of execution (200) according to an exemplary embodiment, refer to FIG. 2.

If the user does not have a permanent license, the client checks if the user has another kind of license (120). If in the affirmative, user's balance is checked and optionally updated (400), as described in detail in FIG. 4. If the check shows that the license allows user to use the software (130), the software is executed (200).

If in (120) the answer is negative, namely, the user has no license for the software, a trial status check and registration process (300) is optionally run, as described in detail in FIG. 3.

If in (130) the answer is negative, namely, the license (or lack thereof does not allow the user to use the software, the software is quitted (140).

FIG. 2 is a flow chart of the process 200, for using a protected software licensed in accordance with an embodiment of the invention. In an exemplary embodiment of the invention, this process executes entirely on the local component of the licensing system, and therefore, the software may run undisturbed even if the client is not online. Process 200 includes activation of the software 210; and an optional monitoring loop 220, which runs as long as the software runs. Loop 220 monitors and logs use of the software. In the embodiment depicted in FIG. 2 loop 220 includes waiting for a predetermined time period to lapse (230), and when lapsed, checking (240) if the user is active. If not, another predetermined time period is waited. If the user is active, the activity is written to a log (250), and the license balance is updated (260). (Initial license balance is created with registration; see FIG. 3). Other methods of sampling usage may be used, for example, logging in response to software, input or output events. For low cost usage, low granularity sampling methods may be acceptable to the user and/or vendor. Optionally, the frequency of sampling is less than once per 100 ms, less than once a second, less than once in 5 seconds or intermediate, smaller or higher sampling rates. Lower sampling rates may be associated with lower computer resource cost for usage monitoring.

In some embodiments, when license balance is updated to be below a low watermark the user is alerted, and when at or below a zero mark, software run is optionally terminated. Various types of forgiveness may be provided in some embodiments of the invention, including, for example, allowing usage even with balance below zero mark for small number of “units” or time (not necessarily the same usage units as logged), allowing reduced functionality of the software and/or allowing only short usage spans of the software, for example, to allow exporting a document from the unlicensed software.

Alternatively, when the license balance is below a low watermark, an update to the server is initiated only when the software is entered the next time, so the user will not be stopped in the middle of using the software. In one embodiment, the message will say that the software cannot function unless the user goes online. When the user is online, report on usage will be sent to the remote component, and it will send in return a new license certificate that will allow the user further use of the licensed software. However, if the remote component is unsuccessful in charging the user for the usage already made (for instance, because the credit card number is not valid any more), the remote component might refuse sending another license certificate until the old usage is charged for. In such case, further use of the software is optionally limited or not allowed at all.

In another embodiment, a notice is sent whenever the license is updated to below the low watermark, even while the software is running. This update initiates the server to send a “fresh” license to the client, to be immediately installed (optionally with additional permanent licenses according to the usage reported). The user is optionally alerted only when such updates are not possible and the license balance is below the zero watermark. In yet another embodiment, the software run is actually terminated in mid run, if the license balance is below zero. Optionally, data is saved before the software is terminated. Optionally, one or more noticeable warnings are provided to the client. In systems where users are not available at all times (such as server applications), a notice may be sent to a designated location, for example, by e-mail or SMS. In other embodiments, after some predetermined offline usage the user is requested to go online, so its account may be updated, and new license certificate issued if required. If the user does not go online for some predetermined usage period after being requested to, she is not allowed to use the software until a “fresh” license is issued by the server, communicated to the client and is installed (or “stored”) on the client machine.

In some embodiments, a significant role for the license management software on the client machine is to enforce the user to report the usage by being online reasonably frequently, which is, for instance, at least once a month (e.g., based on calendar time), once every 20 hours of usage (e.g., based on the usage rate) and/or once every $10 (e.g., based on cost accumulation).

In an exemplary embodiment of the invention payment is not enforced, and sending new licenses continues, optionally, while the user is being reminded of her debt.

In an exemplary embodiment, the remote component is also used for updating version of licensed software, and optionally, this service is not provided for users that are in debt to the system.

FIGS. 3A and 3B together are a flow chart of a registration process 300, in accordance with an exemplary embodiment of the invention. The process optionally begins with a trial status check 305. This is necessary only if the software allows trial periods. If not, or if trial expired, a registration message is presented to the user (310), and registration begins. If trial not expired, the user is suggested to register (330), and if does not want to, the user is allowed to use the software (340). In some embodiments, usage under such circumstances is limited until the end of the trial period, until exit of the software, or the like.

If the user does want to register, registration information is requested (320) and transferred to the remote component. If in response to registration information request the user changes her mind, and decides not to register, or if registration fails for any other reason (for instance, credit card number is not valid) the client checks trial status (350), and if not expired, the user is allowed to use the software. If trial expired, user is not allowed to use the software (355). It should be noted that alternative to registration, a user may be allowed to pay without registering, for example using an anonymous payment method or using a payment service such as “Pay Pal”. As anonymous paying method is more difficult to enforce, in an embodiment of the invention accounts paid this way have only short grace periods, and some of the processes of automatic recharging are absent. Optionally, payment is done by buying a prepaid card (for instance, in stores) and just use its number to gain the license balance, to get “coupons” for limited usage, to use third party calling cards in order to pay, etc.

If the user does register, the remote component attempts to create (360) an account and if succeeds, generates (370) a new license. The new license is sent to the local component. The status and license balance are updated (380) in the local component and the user is allowed to use the software (340).

In an exemplary embodiment, account creation includes receiving billing information from the user, and optionally also includes charging a pre-payment. In some embodiments, pre-payment is not charged, and the user is billed each time only for the usage already made.

FIGS. 4A and 4B together are a flow chart of a process 400 for checking and updating a license balance, in accordance with an exemplary embodiment of the invention. The process is optionally executed during start protected software process 100, as explained in relation to FIG. 1.

The process optionally includes a check 410 if license balance is below a predetermined low limit (also referred to as low watermark), and if not, the user is allowed to use the software (415). This check is optionally run by the local component of the system.

If the balance is below the low watermark, the local component requests from the remote component additional license(s) (420).

In some embodiments, if the remote component is not reachable, for instance, because the client is offline, a suitable message appears but software usage is still allowed. Optionally, if connection with remote component is still not established, user is allowed to use the software only as long as the local license balance is above a zero watermark.

The remote component updates (425) the account balance, optionally, in accordance with the software usage, as this appears from the log created and updated by the process 200 as described above in relation to FIG. 2. The remote component checks (430) if the user's account balance is above a sum stored on the remote component, and if in the affirmative, generates a new license (435) and sends it to the local component, which updates its records accordingly (440). In an exemplary embodiment of the invention, at this time, the remote component also checks for the user's right to receive permanent licenses for some of the software he uses and communicates such permanent licenses to the local component.

The client checks (445) if license balance is above a zero mark (which is lower than the lower watermark, checked in 410), and if so, allows the client to use the software (415).

If the account balance is not above the predetermined sum, the remote component checks if the license terms allow for automatic recharge (450), if so, it tries to recharge the account (455) and if succeeds, generates new license (435), and sends it to the local component.

In an exemplary embodiment, licenses are sent to the client machine via a secure connection, and are installed in the client by the system itself without requiring any involvement from the user.

In exemplary embodiments, licenses are signed by one or more of a hardware fingerprint and the user's account number, to prevent the transfer of licenses from one user to another. Optionally, the licenses and/or balances are encrypted. Optionally, the information about what licenses each user account has is stored on the remote component, and providing a user with license that may be used on a different or additional machine may be carried out only at user's request. This option may be useful in preventing illegal and/or unpaid distribution of licenses. Optionally, the licenses and/or balances are stored on a removable dongle or flash memory device. Optionally, a user can carry such licenses between computers. Additionally or alternatively, the user may access his set of rights through a login to a remote server.

Alternatively or additionally, the licenses (and/or license balance) are stored in a system registry of the user's computer, with each item taking up one or more entries, optionally, with multiple items taking up a single entry. Alternatively or additionally, the licenses and/or balances are stored in the software. Optionally, the licenses and/or balances are stored as files. In some cases, a license certificate is provided as two files, one of which is a certificate and the other is a balance, where only the balance is updated by the server with regard to usage tracking.

In an exemplary embodiment of the invention, the local license has a built-in expiration date, for at least some of its usage units. Thus, an old license turns stale and optionally invalid and optionally forces connection to a remote server and provision of a new license. Stale licenses may have limited or no ability to allow software use, depending on the implementation. This may reduce stealing of license. It should be noted that in systems where a user pays based on usage, the user will optionally not be charged for stale licenses, since there is no corresponding usage.

In some embodiments, before a new license is generated (here, or anywhere else in the operation of the system), the user's charges accrued so far in relation to the license are checked, and if exceed some cap value, a free license is generated. Cap embodiments are described in more details below.

If license terms do not allow automatic recharge, the remote component optionally informs the client's component accordingly, and the client's component requests the user to supply billing information (460). If properly provided, the account is recharged by the remote component (455).

If the account is not recharged, local component checks (445) if license balance is above a zero mark, and if so, allows the client to use the software (415). If license balance is below the zero mark, the user is not allowed to use the software (465).

### Detailed Description of Exemplary System

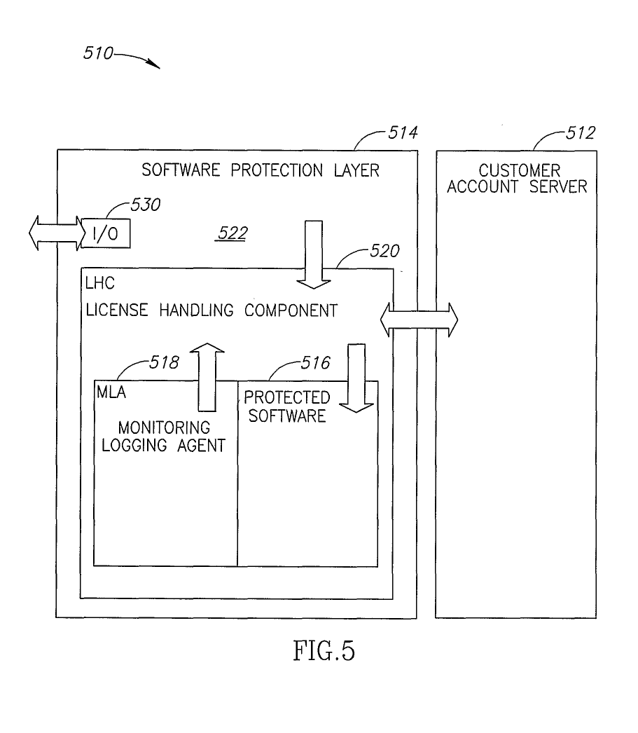

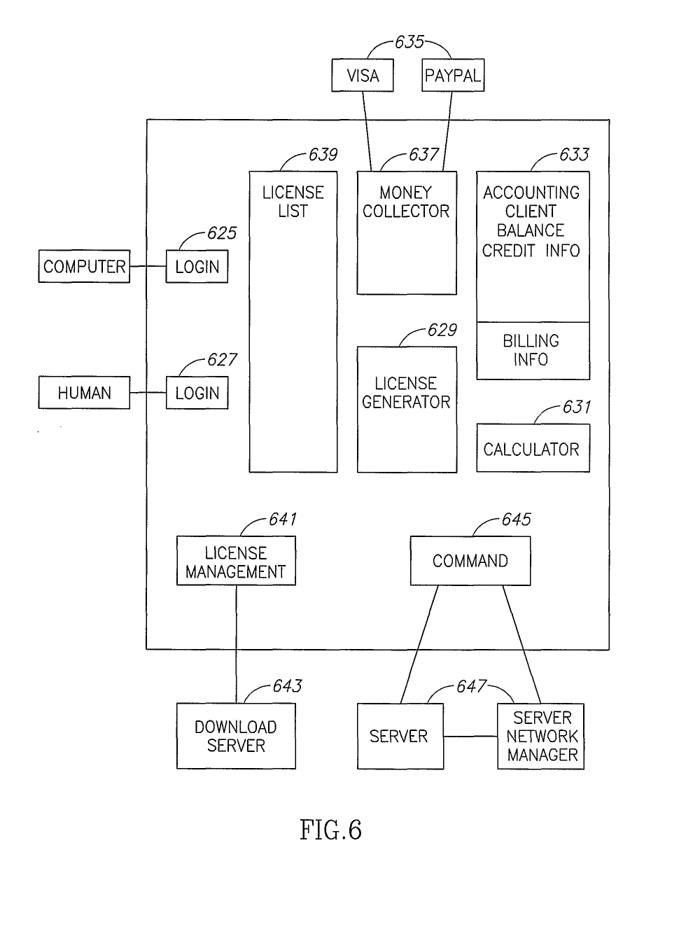

FIGS. 5 and 6 describe a licensing system that is capable of facilitating carrying out the licensing method described in FIGS. 1-4.

FIG. 5 is a block diagram of a licensing system according to one embodiment of the invention, and shows the local component in detail and the remote component in general. FIG. 6 describes in greater detail an exemplary structure of a remote component. It should be appreciated that various functions described herein as belonging to a client or a server may be on a different component from the one shown. For example, billing and license generation may be local rather than remote, while local license balance calculation may be remote rather than local.

FIG. 5 is a block diagram of a licensing system 510 composed of a server component (also called remote component) 512 and a client component (also called local component) 514.

In an exemplary embodiment of the invention, protected software 516, which is the software or software package(s) to be controlled by licensing system 510, is integral with the local component 514 of the licensing system. Optionally, software 516 is protected by a software protection layer 522, which may be, for instance, an encryption layer, which prevents tempering with software 516, or any of the other components described below. Various means for protecting software from usage without a license are known in the art and may be used.

In an alternative embodiment, the local licensing components are separate form the software, for example, being a hardware element (e.g., on a dongle) or being installed into the operating system of the client computer.

In order to charge per use of software 516, the usage of the software is optionally monitored and/or logged by a monitoring/logging agent 518. Logs created by agent 518 are sent to remote component 512, where they are used for updating license and account balances. Logs are optionally stored outside protected software 516, but are optionally digitally signed and/or encrypted.

The rights management of the various software packages is optionally handled by a license handling component 520, which is optionally in charge of requesting further licenses from remote component 512 and deciding whether further use of software 516 is allowed to the user in accordance with its license balance and agreement terms.

Another component shown in the figure is an optional user I/O port 530, which may be used by customers to view and change their account status and preferences.

Optionally, the local component receives a dongle for identifying the user and/or storing sensitive information such as the licenses or balances, and this dongle is optionally also used for protecting the licensing system from an unauthorized use. Alternatively or additionally, the software is programmed in a protected or coded manner, or signed with digital signature. Dongles are known in the art and may include, for example, a USB software protection dongle.

FIG. 6 is a block diagram of a server component 512 according to one embodiment of the invention. Server component 512 is optionally used to verify or update the customer account information and status, and/or create of additional licenses.

Server 512 is optionally used for initial account registration. A version of system 510 is optionally operated without server 512, in which case the account verification and update may be done, for instance, manually or on local component 514, while billing may be done via mail, phone confirmation, online through other services, or by any other means known.

In the embodiment shown, server component 512 has a computer login 625, for allowing communication with client components of various users, and with servers of distributors and owners of protected software. This login optionally uses secure and/or encrypted connection methods, for example as known in the art. The server component 512 also has a human login 627 for allowing users to request registration, change their status or communicate, and the like.

As noted above, from time to time local component 514 may request remote component 512 to issue a new license. Such new licenses, as well as all licenses that may be required for the operation of the system are generated by an optional license generator 629.

Optionally, before a license is issued according to a request of the local component 514, this request should be permitted by a calculator 631, for example, in view of information provided thereto from a license management module 641.

License management module 641 optionally decides on issuance of new licenses responsive to information provided thereto from an accounting module 633, which keeps the account balance and billing info of some or all users. Accounting module 633 is optionally in communication with credit card servers 635 (or other acceptable payment services), through which users are charged in accordance with billing information they provide upon registration. The charging is carried out via a money collector module 637. It should be noted that in some implementations, a plurality of servers are provided instead of a single server, for example, different servers for different functions or different servers for different locations and/or client groups. Optionally, a central server is provided for coordination between such servers, but it is not essential, as distributed methods of severing are known in the art.

In embodiments where licensing system 510 has more than one remote server, it may also include a command module 645 to communicate with other servers 647 that are part of the licensing system, and one of them may be a server network manager.

Each unit included in the remote component 512 or in the local component 514 is illustrated above as a single unit for ease of representation, but the system may include more than one unit of each type. In most cases, the system includes many local components, as each registered user has at least one such component.

Server 512 optionally includes a storage 639 with list of existing licenses, which may be grouped by user, license type, software licensed and/or various other criteria, and used by the other modules for accounting, billing, and/or decisions as to issuance of new licenses.

An optional component of the remote component 512, directed to communication with the license providers and the licensed software owners or distributors, is a Content Owners Reporting Server 650. Such a connection is optionally used by content owners and/or vendors for receiving data, such as statistics, for example, for viewing the status of their software licensing, usage reports and/or commission reports.

Server 512 in the depicted embodiment has an optional download server 643 for allowing a user to download licensed software.

### Exemplary User Registration and Usage Process

A user of the licensing service may reach the content using various methods. For example, a user can search for software or content over various distribution channels, she might access web portals supporting the service, get a copy of the software on a CD, buy hardware with bundled content, physically move to a computing station that includes the software (e.g., at an airport), or acquire the software code by other means, such as peer-to-peer networking. Such software will optionally be marked with a mark indicating that the software may be used by service members.

Once the user finds the software or content she wishes to use, the user (optionally downloads and) installs the software on her machine, following a standard software installation process.

When a non-registered user enters a site that contains such content marked as available under the licensing system, the user can download the software freely and install it on her machine. Then, she can access the software or content for the trial period, if such exists. Registering or activating the software with the content owner is optionally not needed. However, in some implementations, the software owner may allow pay-per-use as described herein but still require activation or registration for example to prevent piracy and/or track usage.

Optionally, every time a non-registered user accesses the software or content, she would get a splash screen (“intro” screen) that will offer her to register or to go on and use the software or content for the trial period. Once the trial period is exhausted, she will no longer have this option—only to register or to quit. Additionally or alternatively, she would be able to make a one time purchase at a full price.

Optionally, catalog web sites are available which include lists of available titles, optionally searchable and/or listed by categories and/or with reviews. Optionally, pricing is displayed for each title. Optionally, pricing is different for registered and non-registered users or for various plans, such as plans where a user has a higher credit or deposit or for users with lager or smaller usage rates.

Once the user registers, she is “forever” registered, and will not need to register in order to access each title available for the licensing system, even if it is from a different site, developer, vendor, different type of content etc. According to some embodiments, a registered user is allowed to restrict her registration to specific sets of content (e.g. a user would register for the music pieces on AOL only). Additionally or alternatively, such user is allowed to expand her registration to other sets without having to re-enter her billing or personal details, just her approval for the expanded access would be required.

Optionally, a registered user is able to install content in much the same way. However, she will not see any splash screen when accessing the software or content, she will be able to access the content seamlessly. As a registered user, once she accesses content, this usage would be logged and reported to the remote component, which will also manage charging.

In one example, assuming the user is using computer games which are included in the system and the licensing terms include a charge cap. She plays Game1 for five hours, Game2 for ten hours and Game3 for three hours. This activity is reported to the back end. If the prices of Game1 and Game2 are 80 c/hour, and the price for Game3 is $1.2/hour, then the user account will be deducted by 5*0.80+10*0.80+3*1.2=$15.6.

Assuming the full purchase price for Game2 is $10. The user has already paid 10*0.80=$8. Now, next week the user plays five more hours on Game2. The log reports these five hours and the server calculates the charge which is 5*0.80=$4. However, since the user already paid $8 and the purchase price is $10, the user would be charged with only $2 for the usage of this game, AND will receive a full and permanent license for Game2. From now on, she will not be charged for the usage of Game2 any longer.

It should be noted that the “charge cap” need not be exactly the full purchase price, but, say, 20% more. Alternatively or additionally, recorded payments may slowly degrade, for example, if there is no or reduced activity, the “recorded payment” is reduced by 10% a month.

In another example, assume such software is provided at a billing rate of $1/hour, and that the user used it for 3 hours. At the same time, the user has also used two other software titles, one for 2 hours, and the other for 5 hours.

Following the usage, the system reports the usage data to the server according to the methods described herein. The server calculates the amount to be billed, for example, according to the usage and billing rate. In this case the user will be billed $3 for the usage of the installed software. She will also be billed for the two other software titles used based on their individual billing rates, for example, $1/hour and $2/hour accordingly, resulting in charges of $2 and $10 and a total charge of $3+$2+$10=$15 for the reported period.

In the next period, the user does not use the software at all, and will not be charged for it.

After a few months, the user may reach the cap for the software, at which point she will no longer get charged for using this piece of software.

Some embodiments may include presenting the user with a notification message when the user first activates a software, or every time that the software is activated to inform her of the fact that she is going to be charged for the usage of the software and/or the billing rate and cap associated with the software.

Optionally, the notice includes information about the amount of credit towards “purchase” accumulated by the user thus far, and how much usage time (or other usage unit) or estimated calendar time is left until the user may receive a permanent license.

Optionally, a message is provided to the user when she finishes using the software including the total time measured, charges, and accumulated charges on the software used.

Some exemplary ways of operating a licensing system as described above, will now be described.

### License Management

The described system is capable of handling various kinds of licenses, some of them listed below. In exemplary embodiments of the invention, one or more of those are suggested to a user to choose among, or assigned automatically in accordance with identified needs of the user, her recorded usage of various software titles, the type of content and software offered (e.g. professional software would probably use different kind of pricing schemes than games), and the various plans that are offered on the distribution site. It is a particular feature of some (but not all) embodiments of the invention that a single licensing system provides multiple license types including limited usage licenses, permanent licenses, site licenses and/or package licenses. Exemplary types of licenses include:
(a) Permanent licenses for the use of a specific piece of licensed software. Such license allows for the unlimited usage of the applications and content pieces under its protection. In some embodiments, such licenses are provided once the payments made by a user on a pay-per-use basis accumulate to a cap sum, such as the purchase price of the licensed software.
(b) Temporary unlimited licenses for the use of a specific application or content piece (or alternatively a group of specific applications or content pieces). Such license allows for the unlimited usage of the applications and content pieces under its protection for a set period of time (e.g. unlimited usage for the month of February). In some embodiments, such licenses are provided once the payments made by a user on a pay-per-use basis during some time period accumulate to a cap sum, such as the prescription price of the licensed software to a similar period.
(c) Trial licenses for the use of a specific licensed software. Such license allows for the usage of the software for a limited trial period (e.g. one hour of usage, 14 days of usage since installation, until a set calendar date etc.). In some embodiments such trial period is provided free of charge, and charging begins only when the trial period ends. In exemplary embodiments, trial grant is cumulative over several pieces of content, namely, the user may try any one of the software pieces on trial for a total number of usage units.
(d) Registered user license for the use of one or many licensed software titles. In an embodiment of the invention these licenses are limited both in total usage time (e.g. 30 hours) and calendar date (e.g. one month after creation). Alternatively a registered user license is limited only in total usage, or only to a certain calendar date. In some embodiments, registered user licenses are given on a pay-per-use basis. In some embodiments, such licenses are recharged and renewed automatically.

In some embodiments of the invention, the user's usage of the software includes going through multiple phases, each uses a different license type, for instance, a user is granted a free trial license; when this is expired, the user moves, automatically or manually, to pay-per-use registered user license, and when a cap charge is reached, the user is granted an unlimited usage license. In some embodiments, a user is allowed to choose to have all these movements from one kind of license to another automatically, without needing to pay them any attention, while ensuring a well designed cost effectiveness. If the user stops using the software during the trial period, it will costs her nothing, if she uses it only little bit afterwards, it will cost her according to use, and if she uses the software heavily, it will not cost more than purchase of the software.

### Charge Cap

In accordance with some embodiments of the invention, a permanent license to a software title is granted to a user that used a software title under a pay-per-use license, and was charged under this license a certain sum, which is referred to herein as a cap charge or charge cap.

Optionally, the certain sum is predetermined, optionally it is set by rules, responsive to characteristics of the user, usage made, software title, and/or promotional programs.

A fixed cap may reduce or nullify any risk the user is taking by paying per usage, because whatever happens, charges will not be more than an alternative full purchase price or other predetermined amount. Such risk reduction may also reduce motivation for piracy, as the payment terms may be planned to be very convenient and fair towards the user. As noted above, more complex capping schemes may be provided as well, for example, decaying capping.

In an exemplary embodiment, each time a user is charged for using a specific software title, this information is saved in an accounting database, and the total charges a user paid for usage of this title are summed from the database by the calculator. This sum is reported to the license managing module in the remote component, and compared to the cap charge stored therein. If the charges reach the cap charge, the license managing module instructs the license generator to generate to the user a permanent license for the software title, and this license is sent to the client component of the system.

In an exemplary embodiment, the same principle of capping the charge is applied for monthly subscription (for instance, instead of paying $10 per month, pay 20 cents per use, but no more than $10 per month).

In some embodiments of the invention it is possible to change the cap charges, namely, the maximal charge that is collected for use of software title before a permanent license is granted. In one embodiment this is done in accordance with predetermined rules, for instance, the cap charge per software title depends on the usage of other software titles, on the usage made by other users, on the time period during which the usage was made (for instance, heavy users may have lower charge caps, and/or that non-users are removed from the charge-cap plan). These rules are optionally maintained at the license management module on the remote server, and which instructs the calculator to perform the relevant calculations, based on registration files kept by the accounting module. In accordance with the results of the calculations, and responsive to the rules, the license management module decides when a permanent license should be granted to a user and instructs the license generator accordingly.

In some embodiments of the invention, the user may have the choice to pay some of the cap charge in cash instead of per use, in order to be granted the permanent license immediately. In one embodiment, for this, the user enters the user i/o port on the local unit, and changes her preferences. In some embodiments the user may choose to pay in cash instead of in use by accessing a detailed activity listing, from which she may check a “buy now” box near a software title on her list. The new preferences are transferred to the remote unit for implementation. Optionally, the user may be charged with more (or less) money in cash than by per-use for obtaining the permanent license. Alternatively, access may be via a web interface.

In one embodiment, the charge cap is for a group of applications or content pieces. In a particular example, a user gets charged for all card games up to $80, each game by its own price per minute, and then is allowed to play all card games freely.

In an exemplary embodiment of the invention, the cap is set on total usage of all packages instead of a single package. For example a user will never get charged more than $15 every month regardless of how much she used the software or a group of software. This particular model combines the features of a subscription model and a pay-per-use model. Optionally, multiple types of charge caps are combined and/or provided in the alternative.

Optionally, the permanent license may be used for any of a group of software titles. However, the number of simultaneously usable titles may be limited to the number of permanent licenses.

Optionally, for some titles, a permanent license which is not linked to any particular title or one which is not for a specific title may allow usage of the specific title at a lower rate. Optionally, rate lowering licenses or changes in rental terms are available based on usage, for example as described for general caps. Rate reducing license or rental term agreement changes may be temporary in nature, for example, time limited, usage limited and/or title limited e.g., a vendor may use them as a promotion. Optionally, if used as a promotion, the cost of the reduction in collection may be reimbursed to the licensing server by the vendor. Alternatively, a rebate directly form the vendor to the user may be provided, for example, by mail or e-mail, as money, goods, coupons and/or other special considerations, such as memberships.

### Monitoring and Logging

In an exemplary embodiment of the invention, the usage of the various licensed software titles is monitored while they are in use, and this usage is logged for reporting purposes. One purpose of this monitoring/logging process is to enable the system to charge the user per usage, and/or to allocate the charges to the specific software titles used, for example for revenue sharing purposes.

Usage may be determined in many methods. Non limiting examples of such methods are: determining whether or not the application window is active; whether or not there was a key stroke, a mouse click or a mouse movement since the previous check; whether or not there was network activity; and whether or not the licensed software was reading or writing to a file. Usage may be determined by one such method or by a plurality thereof. According to an exemplary embodiment of the invention, if the activity monitoring determines that the user has not used the software, the user will not be charged for the time of inactivity. Optionally, this feature is activated only for specific set of software (e.g. shooting games) and not others (e.g. chess) depending on the level of activity characterizes them. Optionally, an interface screen telling the user that her charge was stopped because of inactivity is presented.

Other methods for determining activity include monitoring the CPU usage, disk usage and/or usage of other system resources done by the software. This is particularly useful in cases where the software is of a type that is generally used without constant user interaction, such as a firewall software. For protection software, charge can be, for example, per security risk detected and/or neutralized, for example, per virus blocked.

In one embodiment, monitoring is by a monitoring/logging agent, which is a part of the local component of the system. This module is started when the licensed software title is activated. It constantly measures the activity level of the licensed software title to determine whether or not the software title is actually in use, or rather is operated without any actual use. This measurement is not necessarily applicable to types of software titles. When indeed the software title is in use, the monitoring component logs the usage (and optionally also the non-usage) in a periodic manner (e.g. once a minute), and the log entry includes the time stamp, the software title ID, and optionally additional information that would enable the allocation of the usage to the application or content piece.

The log entries are optionally saved in log repository. Such repository may be hidden, be in a registry, be regular files and/or be stored using other methods known in the art. In an exemplary embodiment, the information in the log is encrypted and/or signed. Optionally, a new log file is created for each activation of a software title. A log analysis process may be performed on the log files by the Monitoring/Logging module of the local component in order to aggregate the data for reporting to the remote component. Alternatively or additionally, raw log information is sent to the remote component and analyzed there. After reporting and receipt confirmation, the files are optionally deleted (or otherwise marked as used) to prevent duplicate reporting.

As noted above, “usage” towards purchase of software may be paid for. Alternatively or additionally, other schemes for such payment are provided. For example, as a promotion, bonus points may be provided for usage of certain software. Reporting to the software vendor may be used to indicate a success of a marketing campaign. Similarly, coupons may be provided. Alternatively or additionally, for some usage patterns, bonus usage points may be allocated. Optionally, the balance of bonus points are stored at the server and/or locally. Optionally, a preferred customer is one who accumulates many usage points and/or is a heavy and paid-up user. Optionally, such preferred customers are provided with breaks and/or better credit terms. Optionally, customers that use test software such as beta or alpha version or during pre-marketing surveys are paid for such usage, for example, by being provided with bonus usage points.

### Reporting and License Update

Reporting the usage of the licensed software is an important component of some embodiments of the invention, as it is a basic parameter in some licensing agreements, and is relied on for charging users and for revenue sharing. For instance, the reporting may be used to calculate total charges of the user.

Transferring of the log files from the client component to the server one (also referred to as reporting the usage information) is optionally limited to when the client is online. In some embodiments, transfer takes place each time a client is online, in other embodiments, transfer takes place only when the license balance is below some watermark. In one embodiment, the logs are reported online, and this limits usage of licensed software only to times where the user is online. In other embodiments, when the user is online logs are saved on the remote component, and only when the user is offline the logs are saved on the local component. Optionally, a user can send such logs using e-mail, for example, if the user is using a secure computer which is not allowed connection to remote servers. In such a case, the local component and/or other software generates a report in a secure format, which report is optionally transferred to storage media and to another computer. In reply, a license may be provided which is installed by the user on the secure computer. The license is optionally provided as a self-installing file.

In some embodiments, a report is sent periodically, in other embodiments report is sent on usage base for instance, every 30 hours of usage.

The report sent from client to server component optionally contains raw log files, analysis of log files, or both.

Some possible ways to verify that the logs were not tampered with are described below in the section titled Online and Offline Operation.

Online and Offline operation

In some embodiments of the invention users may use the system while being connected to the Internet, or while being offline. In some embodiments that allow offline operation, the system manages a local license and maintains a local log of the user's activity.

Optionally, both the license and the local log are protected and coded or encrypted to prevent the user from manipulating them.

In some embodiments, once a local license is exhausted, the local component attempts to connect to the server and report the usage data. Alternatively or additionally, the local component may attempt to connect to the server whenever the system is started. In an embodiment, the report includes analyzed usage data and current local license balance. The calculator of the server component is then capable of calculating the total user charge based on reported usage data, order the license generator to generate a new license, and the license handling module may thus send to the client component new licenses as required.

Once the new license is installed in the client's component, further offline usage is enabled.

If the local log files are accidentally deleted, or in case that the total time reported in the local log files does not agree with the local license balance, the system may be programmed to react in various ways. In one embodiment, the system charges the user based on the license balance, the log files, or any other criteria that would be agreed upon in the license agreement. The agreement will also include ways for assigning usage to individual applications and to calculate user's right for permanent license in such cases.

In some embodiments, if the total time reported in the log is less than the license usage, only the logged usage will be credited to the user, and the additional unlogged usage will be charged without being applied towards a permanent license (e.g., user license equity).

In some embodiments, if the total time reported in the log exceeds the license usage, it will be scaled down by the ratio of the license used divided by the total logged file, so that the total credit attributed to all applications will equal the total license usage. Content owners will receive their share of the revenue based on the same usage ratio between the different applications used by the user.

In some embodiments, any inconsistency is recorded on the server, such that users that show frequent inconsistencies may be treated accordingly, for instance, the system may determine that these inconsistencies are due to malicious tampering with the data and may or may not take measures to prevent such future tampering—e.g. contact the user and warn him of that effect, cancel the user account or other means. The type of action may depend on business decisions and the extremity or frequency of such incidents.

### Automatic License Renewal

In some embodiments, when the user first joins the service, the server assigns the user with a unique account number. This number is saved on both the server and the client components and may be used to identify all reports and communication received in the server from the user machine. Additionally or alternatively the client component may calculate a hardware fingerprint of the client's machine, and send it to the server. This fingerprint may be saved on the server machine and optionally is attached to the client account number.

Optionally, the licensing may be possible only for users that work from the hardware, fingerprints of which are associated with the user's account. This may hinder licenses transfer between users and user machines. Furthermore, if a user tries to impersonate another user, and use his account number instead, the license received will not function on the imposter's machine, as the machine fingerprint will not be appropriate. In other embodiments, instead of the account being assigned only to a specific machine, user may “login” into his account on any machine, automatically receiving the permissions of his account. Optionally, user may register more than one machine for the service, having the license either jointly computed on the usage on all machines, or acting as separate accounts that share the billing information and/or account balance. User may also have several accounts for the same machine. As noted above, the identification may be linked to a dongle or a removable storage element.

In an exemplary embodiment of the invention, once a server receives a new license request from a client machine, the server will follow the procedure below:
(a) Receive license usage data from client;
(b) Receive log data from client;
(c) Calculate new user account balance, taking into account usage data and all agreement factors, such as charge caps, usage already reported but not yet charged for, over-usage between logins, etc.;
(d) If the user's balance is below a re-charging watermark (e.g. $2), request the billing system to charge the user's account and update the balance;
(e) If the user's account cannot be charged at this time, and the user's balance is below a usage low watermark (which is lower than the re-charging watermark, e.g. $0 or even negative) send an error message to the client, and do not generate a new license;
(f) If the user's balance is above the usage low watermark, possibly after re-charging the account as mentioned above, generate a new license with a pre-set amount of credit using the user's account number and machine fingerprint stored on the server. The amount of microlicenses on the new License may take into account the actual balance the user has on her account;
(g) If the user reached a full license level for one or more applications (e.g., the charge cap), generate a new permanent license for each of such applications using the user's account number and the machine fingerprint stored on the server; and
(h) Send all new licenses to the client machine.

In some cases, the user will provide credit card information during the registration process and will allow the service to bill the credit card when the account balance is low, and may also provide maximal automatic billing per period (for instance, $7 per month). Such payment may be done automatically without requiring further user authorization.

Alternatively, a user might elect not to be automatically billed. In this case, the server will send to the client a billing authorization request notifying the user that his balance is low, and requesting billing information or authorization to use billing information that was provided to the system before, for instance, during registration.

Alternatively or additionally, a user may buy usage credit through other channels (e.g. prepaid cards) and instruct the system to charge this channel whenever the account balance is low.

Additionally or alternatively, a user may log into the online account management interface to authorize or perform payments instead of using automated renewals. Payment may also be done directly at the client interface.

In an exemplary embodiment of the invention, the server component collects data about the usage of individual software titles, and the revenue generated through that usage. Every such title may be attributed to a specific owner and a specific distribution channel. The server's calculator calculates how much revenue was generated by content owned by each content owner, and by content distributed by specific channel. This data is optionally used to distribute revenue based on commission agreements. The accounting module on the remote component automatically transfers commissions to the content owner or distributor bank accounts, or produce checks for such payments.

### Distribution Channels

In an exemplary embodiment, every application under the service, automatically identifies the common micro-license, writes its usage into a log, and decreases the local available license credit, leading to the eventual billing of the user for the usage of the software. As such, there is no need to limit or prevent users from sending software and content from one user to the other. The user will get access to the software and be charged just as if he has downloaded the software himself or purchased a CD with the software. In some cases, the swifter will be stamped by its source with an ID of the downloader. However, this ID is optionally not used for billing, but rather for tracking which users are leaders and which are followers.

All licenses are optionally seamlessly managed and/or provided to the user via communication between the client component and the server, and all applications consume from a common microlicense source. In this embodiment, there is no need to limit the transfer of applications from one user to another, only to protect the transfer of licenses from the system server to the user. Optionally, peer-to-peer transfer is encouraged.

Optionally, once a user starts using any application under the monitoring of the client code, it will automatically use the local license file, and log its usage to be reported to the server. Finally such usage will be reported to the server, along with the user's account number to be billed to her account.

In an exemplary embodiment of the invention, applications may be distributed independently on multiple channels, and do not require any activation process to be used. Such channels may include: downloaded applications from the Internet; applications or content streamed to the user; applications and content distributed on different forms of media, such as CD, DVD and memory cards; applications and content distributed over P2P networks; applications and content sent from one user to another via email; applications and content pre-installed on the user's machine by the vendor selling the machine or other 3^{rd} parties.

### Plans and Promotions

A system as described above can support various plans and promotions. Non-exhaustive examples to such plans or promotions include:

(a) Bring a friend—user that has sent her friend to register would get benefit from such registration that may also depend on the level of usage her friend has with the system (for instance, get one hour free for every paid hour your friend had with the system in her first three months after registration).

(b) Sales—for instance, games played during the Holiday Season get a 50% discount, users who register during a promotion period may receive discounts or bonus credit to their account.

(c) Frequent user—user gets bonus for frequent usage of applications or content pieces that are included in the service. For example, users who used more than a certain number of hours in a single month may receive free usage time in the next month.

(d) Loyalty points—users may receive loyalty points based on their usage of applications. Loyalty points may be used in the future to purchase additional content offered by the service or other partners.

(e) Volume discount—users who chose to refill their account with a higher amount every time may receive additional credit to their account. For example a 10% bonus on refill amounts over $50.

In some embodiments of the invention, the ability to offer broad flexibility in plans and/or promotions originates, at least in part, from tracking at the client's side coupled with rule application and charging at a server. Updating the server is generally simpler than updating clients. Broad flexibility may originate in some embodiments from the ability to translate various promotions into future use of software, the translating optionally being in a straightforward manner.

### Application to Music and Other Content

While the above has focused on software, similar licensing schemes may be applied to music or other content, such as movies, audio, images, IPTV, Premuim Channels, and cellular ring tones. Such content may be viewed or played by commercially available applications, such as Windows Media Player. One embodiment of licensing such software titles is to provide them encrypted, and licensing a mediator application that is capable of decrypting them for the time they are viewed or listened to. In such embodiment, the local component monitors and logs the use of the mediator application and the identity of the licensed software title decrypted thereby.

In an alternative embodiment, the content is shown on dedicated hardware, such as a set-top box, a DVD player, a television, a cellular telephone, an MP3 player, PDA, and Mobile DVD Player. In an exemplary embodiment of the invention, the hardware is configured using suitable circuitry and/or programming to track usage and licenses. Optionally, if the dedicated hardware includes a communication port, this port is used for reporting and downloading licenses. Alternatively or additionally, the device may be attached to a communication device (e.g., a cellular telephone) or have licenses downloaded thereto. The type of feedback to a user may depend on the device. For example, a DVD player will give visual notices, while an MP3 player will give audio notices.

Optionally, a set of microlicenses can be downloaded and paid for. Optionally, the dedicated hardware can generate “change” from a license which can be uploaded to a server and redeemed for cash and/or other consideration, if the entire license is not used.

### Monitoring Logging Agent

As noted above, a monitoring/logging agent may be provided as part of the client software. In an exemplary embodiment of the invention, the agent is provided as a separate running thread which is executed as the software starts. In some embodiments, this is done in-order to not interfere with the intended execution of the original software package. Moreover the thread may employ stealth techniques in-order to hide its own existence from the original application, as it may be required for a correct execution.

In an exemplary embodiment of the invention, this thread sleeps and is awakened at a relatively low periodicity and/or in response to events, so its overhead may be low, for example, consuming less than 5% of the computer resources.

In an exemplary embodiment of the invention, the monitoring agent is embedded into the original software and hooks into various functions called by the software. In an exemplary embodiment of the invention the monitoring agent, wholly or partially, is on the LAN.

In an exemplary embodiment of the invention, the software is compiled to include the agent, for example, by linking to suitable libraries, in-line coding or replacement of an existing DLL by a DLL which includes the monitoring agent. Optionally, the operating system is modified to include calls to the agent.

Various methods of protecting existing software or writing software so that it must access a license or a dongle are known in the art and may be used, with the agent being the part that accesses the license.

Optionally, content owners and distributors will be receiving their share of the revenue based on prorated revenue as collected from all users of the system, or according to other business agreements with them. Optionally, limited number of software licenses that allow sublicensing will be purchased or rented from the vendors by the service providers, and only these will be made available to users of the service.

### General

The present invention has been described using non-limiting detailed descriptions of embodiments thereof that are provided by way of example and are not intended to limit the scope of the invention. For example, the client and server software described above may be implemented in more modules than mentioned above (e.g., one or more of the tasks described above is being performed by a single module is performed by a plurality of separate cooperating modules) or in fewer modules than described above. In an exemplary embodiment of the invention, each of the client and/or server software is implemented by a single module. The software may be executed as a single process or as a plurality of cooperating processes.

The software modules may be implemented in substantially any suitable software language such as Java, Pascal, C++ or assembler and may be precompiled or may be compiled or interpreted each time the software is executed.

It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. The present invention includes software, computer readable storage media (e.g., diskettes, USB flash memory units, CDs) on which the server and/or client software are stored, as well as computers programmed and/or configured with the above described software.

In some embodiments of the invention, rather than implementing in software, the above described tasks may be executed partially or entirely in firmware and/or hardware (for example in a client plug-in), for example in order to prevent tampering and/or copying. In relating to a computer in the above description, the description is not limited to all the tasks of the computer being performed by a single processor or by hardware (memory, disk drive, modem) included in a single housing and considered part of the computer. Rather, some of the tasks of the computer may be outsourced to co-processors internal and/or external to the computer's housing, for example by a remote unit connected over the Internet.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method for determining a charge for using software, comprising:
(a) allowing execution of a software title by a user;
(b) tracking the user's usage of the software;
(c) determining a charge to the user according to said tracked usage; and
(d) limiting said charge according to a cap.

2. A method according to claim 1, wherein in (a) usage of a plurality of software titles is allowed, in (c) a charge is determined for using each of the software titles, and in (d) charging for each software title is limited by cap associated with this title.

3. A method according to claim 1, wherein in (a) usage of a plurality of software titles is allowed, in (c) a charge is determined for using each of the software titles, and in (d) charging for a plurality of software titles together is limited by a common cap.

4. A method according to claim 3, wherein said plurality of software titles are owned by a plurality of software vendors.

5. A method according to claim 1, wherein charging is only for tracked usage of software.

6. A method according to claim 1, wherein allowing execution comprises allowing execution on an ongoing basis without requiring registration or activation of the software by the user.

7. A method according to claim 1, wherein at least some of said tracking is carried out when the software is used during a time at which the user is not connected to a remote communication network.

8. A method according to claim 1, wherein when charging reaches a cap the user is granted a free license for a software title.

9. A method according to claim 8, wherein the free license is permanent.

10. A method according to claim 9, wherein the cap is associated with a certain software title, and is similar to a price of same software title as offered by an entity associated with said tracking.

11. A method according to claim 8, wherein the free license is limited in time.

12. A method according to claim 11, wherein the cap is associated with a certain software title, and is similar to subscription price of same title, as offered by an entity associated with said tracking.

13. A method according to claim 1, wherein the allowing in (a) is free of charge.

14. A method according to claim 1, wherein after a user is charged a maximum of first agreed sum per month usage of software, if the payments accumulate to a second agreed sum, any further usage is free of charge.

15. A method according to claim 1, wherein usage of different titles accumulate towards a single cap, allowing a free use of one of the titles.

16. A method according to claim 1, wherein usage of different titles accumulate towards a single cap, allowing free use of all said different titles.

17. A method according to claim 1, wherein the cap depends on the user's usage of software.

18. A method according to claim 17, wherein payments that accumulate faster have a lower cap than payments that accumulate more slowly.

19. A method according to claim 1, wherein usage of one user accumulates in favor of a cap of another user.

20. A method according to claim 1, wherein usage of one software title accumulates in favor of a free license on a different software title.

21. A method according to claim 1, comprising purchase of a perpetual license by said user using both credit accumulated by said usage and direct payment.

22. A software usage tracking system comprising:
(a) a local component associated with a software executing on a user's machine, the local component comprising a tracking module operative to track usage of said software; and
(b) a remote component comprising:
(i) an input adapted to receive at least an indication of said usage;
(ii) a storage location having a cap value stored therein;
(iii) a calculator operative to calculate a charge based on said indication and said cap.

23. A system according to claim 22, wherein said local component is associated with a plurality of software titles installed on a user's machine, and the input of the remote component is adapted to receive at least an indication of usage of each of said software titles, and identity of the software title associated with each usage.

24. A system according to claim 23, wherein said plurality of software titles are of a plurality of vendors.

25. A system according to claim 23, wherein the software includes at least 5 different titles.

26. A system according to claim 24, wherein said plurality of vendors includes at least 5 different vendors.

27. A system according to claim 23, wherein said storage location has stored therein multiple cap values and identity of software titles associated therewith.

28. A system according to claim 22, wherein said local component is adapted to carry out monitoring when the user is not connected to a remote communication network, and to send to the remote component at least an indication of the track usage when the user is connected to a remote communication network.

29. A method of charging a user for using software titles, the method comprising:
(a) allowing the user to use software titles of a plurality of different vendors;
(b) tracking user's usage of said software titles; and
(c) charging the user by a single entity for the tracked usage.

30. A method according to claim 29, wherein said plurality of vendors include at least 5 vendors.

31. A method according to claim 29, wherein usage of each title is allowed upon installation.

32. A method according to claim 29, wherein the allowing of (a) is by providing the user's machine with at least one license certificate; and the number of license certificates is smaller than the number of software titles allowed for use by said certificate.

33. A method according to claim 29, wherein said software titles are made available to said user by at least two different distribution channels.

34. A method for using a software title comprising:
(a) connecting to a remote communication network to receive therethrough certain usage units for using software;
(b) consuming at least part of said usage units when disconnected from said communication network; and
(c) reconnecting to the remote communication network to be debited for consumed usage units.

35. A method of using a software comprising:
(a) locating software marked as being available for execution upon installation;
(b) installing the software;
(c) using the software; and
(d) connecting to a remote communication network for being debited for usage made and being further allowed to use software similarly marked.

36. A method of allowing a user to use software titles from multiple vendors; the method comprising:
(a) providing the user with a non-permanent license certificate for using software titles from multiple vendors; and
(b) using said titles by said user based on said license certificate.

37. A licensing method, wherein (a) a remote component sends a license certificate to a local component, the license certificate permitting to run software, (b) the local component sends to the remote component information on software usage of the software by the user; (c) the remote component reacts to the information in one or more of the following ways:
(i) sending another license certificate to the local component;
(ii) billing the user for usage made;
(iii) disallowing further use of software by the user.

38. A method according to claim 37, wherein the other license certificate in (i) allows free use of software.

39. A method according to claim 38, wherein said free use is permanent.

40. A method according to claim 38, wherein said free use is time limited.

41. A method according to claim 38, wherein said free use is limited to a certain amount of usage units.

42. A method according to claim 37, wherein more than one license certificate is sent to the client.

43. A method according to 37, wherein at least one of the license certificates sent to the client provides permanent free use of one or more software titles.

44. A method according to 37 wherein at least one of the license certificates sent allows the use of multiple software titles in a per-pay-use method.

45. A software usage tracking system comprising a local component associated with a software executing on a user's machine and a remote component, wherein:
(a) the local component comprising
(i) a tracking module operative to track usage of said software;
(ii) a report enforcing module, operative to require the user to allow reporting of said usage to the remote component; and
(b) the remote component comprising an input adapted to receive at least an indication of said usage.

46. A system according to claim 45, wherein the report enforcing module requires the user to connect to a remote communication network.

47. A system according to claim 45, wherein the report enforcing module operates a predetermined period after last time the user was connected to the remote communication network.

48. A system according to claim 47, wherein said predetermined period is a month.

49. A system according to claim 45, wherein the report enforcing module operates when not yet reported tracked usage of the software reaches a certain limit.

50. A system according to claim 45, wherein said reporting is by a tamper-detecting connection to said remote component.

51. A method of allowing a user to use software titles, the method comprising:
(a) registering a user with a single registering entity; and
(b) said entity allowing the user to use software titles of a plurality of different vendors responsive to said registration.

52. A method according to claim 51, wherein said registering comprises generating a license certificate for a user associated with a hardware fingerprint of a user machine.

53. A method according to claim 51, wherein said registering comprises generating a license certificate for said user and associated with a hardware fingerprint of a user machine.

54. A method according to claim 51, wherein said registering comprises generating a license certificate for said user and associated with an identification of said user.

55. A method according to claim 51, wherein said allowing comprises allowing use of said titles from multiple user machines.

56. A method according to claim 55, wherein said machines are from a limited set of machines.

57. A method according to claim 55, wherein said machines can be arbitrary.

58. A method according to claim 51, wherein said allowing comprises providing multiple charging plans to said user.

59. A method of charging a user for use of a software, comprising:
(a) transmitting to a user computer a limited usage unit certificate;
(b) allowing usage on said computer base don said certificate; and
(c) charging said user for actual use independent of a number of usage units in said certificate.

60. A method according to claim 59, wherein said transmitting of said certificate is hidden from said user.

61. A software usage tracking system comprising a local component associated with a software title executing on a user's machine and a remote component, wherein:
(a) the local component comprises (i) a tracking module operative to track usage of said software; and
(b) the remote component comprises:
(i) an input adapted to receive at least an indication of said usage;
(ii) a license generator adapted to generate both perpetual and limited usage license certificates for said local component.

62. A software usage tracking system comprising a local component associated with a software title executing on a user's machine and a remote component, wherein:
(a) the local component comprises:
(i) a tracking module operative to track usage of said software;
(ii) a certificate request module which generates requests to said remote component; and
(iii) a certificate installation module which installs a certificate on said user machine without requiring activity by said user; and
(b) the remote component comprises:
(i) an input adapted to receive at least an indication of said usage;
(ii) a license generator adapted to generate one or more license certificates for said local component based on said usage; and
(iii) a license certificate transmitter adapted to send said generated certificate to said local component over a public network.
